(19) United States
(12) Patent Application Publication
(10) Pub. No.: US 2010/0062338 A1
(43) Pub. Date: Mar. 11, 2010

(54) NANOSTRUCTURED ANODE FOR HIGH CAPACITY RECHARGEABLE BATTERIES

(75) Inventors: Justin S. GOLIGHTLY, Sunnyvale, CA (US); Mark J. Isaacson, Santa Clara, CA (US)

Correspondence Address: MCDERMOTT WILL & EMERY LLP, 18191 VON KARMAN AVE., SUITE 500, IRVINE, CA, 92612-7108, US

(73) Assignee: LOCKHEED MARTIN CORPORATION, Bethesda, MD (US)

(21) Appl. No.: 12/558,454

(22) Filed: Sep. 11, 2009

Related U.S. Application Data
(60) Provisional application No. 61/096,262, filed on Sep. 11, 2008.

(51) Int. Cl. H01M 4/58; B05D 5/12

(52) U.S. Cl. 429/231.8; 429/218.1; 427/58; 427/122

(57) ABSTRACT

Nanostructured anodes for high capacity rechargeable batteries are provided according to various aspects of the disclosure. The nanostructure anodes may comprise silicon nanoparticles for the active material of the anodes to increase the storage capacity of the batteries. The silicon nanoparticles are able to move relative to one another to accommodate volume expansion during lithium intercalation, and therefore mitigate active material degradation due to volume expansion. The anodes may also comprise elastomeric binders that bind the silicon nanoparticles together and prevent capacity loss due to separation and electrical isolation of the silicon nanoparticles.

### RELATED APPLICATION

The present application claims the benefit of priority under 35 U.S.C. §119 from U.S. Provisional Patent Application Ser. No. 61/096,262, entitled “NANOSTRUCTURED ANODE FOR HIGH CAPACITY RECHARGEABLE BATTERIES,” filed on Sep. 11, 2008, which is hereby incorporated by reference in its entirety for all purposes.

### STATEMENT REGARDING FEDERALLY SPONSORED RESEARCH OR DEVELOPMENT

Not Applicable.

### FIELD OF THE INVENTION

The present invention relates generally to batteries, and more particularly to nanostructured anodes for high capacity rechargeable batteries.

### BACKGROUND OF THE INVENTION

There is growing demand for high performance rechargeable batteries in applications ranging from cell phones to satellites, including hybrid vehicles, portable electronics, and advanced space and military applications.

Lithium-ion batteries are commonly used for high performance rechargeable batteries. The storage capacity of conventional lithium-ion batteries is limited by the active material. In typical batteries graphite is used, which has a theoretical specific capacity of about 372 mAh/g. Silicon is an attractive material for lithium-ion anodes because of silicon's much higher theoretical specific capacity of about 4200 mAh/g. Thus, silicon-based anodes have the potential to dramatically improve the storage capacity of lithium-ion batteries. However, silicon-based anodes suffer from poor cycle life, which is attributed to active material degradation resulting from the large volume change that silicon undergoes during lithium intercalation.

### SUMMARY OF THE INVENTION

Nanostructured anodes for high capacity rechargeable batteries are provided according to various aspects of the disclosure. The nanostructure anodes may comprise silicon nanoparticles for the active material of the anodes to increase the storage capacity of the batteries. The silicon nanoparticles are able to move relative to one another to accommodate volume expansion during lithium intercalation, and therefore mitigate active material degradation due to volume expansion. The anodes may also comprise elastomeric binders that bind the silicon nanoparticles together and prevent capacity loss due to separation and electrical isolation of the silicon nanoparticles.

In one aspect of the disclosure, a rechargeable battery is provided. The rechargeable battery comprises an anode, a cathode and an electrolyte for transporting lithium ions between the anode and the cathode. The anode comprises a plurality of silicon nanoparticles and an elastomeric binder binding the plurality of silicon nanoparticles together.

In another aspect of the disclosure, a method for fabricating an anode of a rechargeable battery is provided. The method comprises preparing a binder solution, adding conductive additives and silicon nanoparticles to the binder solution to form an electrode slurry, applying the electrode slurry onto a conductor, and drying the electrode slurry on the conductor to form the anode.

Additional features and advantages of the invention will be set forth in the description below, and in part will be apparent from the description, or may be learned by practice of the invention. The advantages of the invention will be realized and attained by the structure particularly pointed out in the written description and claims hereof as well as the appended drawings.

It is to be understood that both the foregoing general description and the following detailed description are exemplary and explanatory and are intended to provide further explanation of the invention as claimed.

### BRIEF DESCRIPTION OF THE DRAWINGS

FIG. 1A shows an example of a battery according to an aspect of the disclosure.

FIG. 1B shows the battery comprising an anode, a separator and a cathode according to an aspect of the disclosure.

FIG. 2A shows an anode comprising silicon nanoparticles and an elastomeric binder according to an aspect of the disclosure.

FIG. 2B shows the anode in a charged state after lithium intercalation according to an aspect of the disclosure.

FIG. 2C shows the anode in a discharged state after lithium extraction according to an aspect of the disclosure.

FIG. 3 is a flow diagram illustrating a process for fabricating a battery according to an aspect of the disclosure.

### DETAILED DESCRIPTION OF THE INVENTION

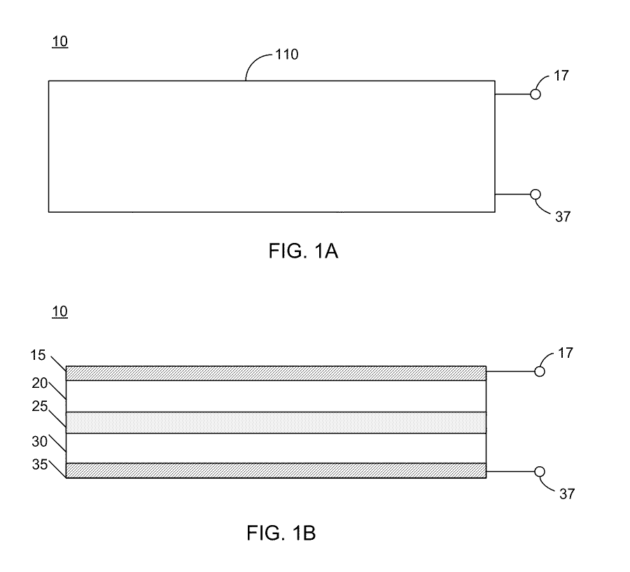

FIG. 1A shows a high capacity rechargeable battery 10 according to an aspect of the disclosure. The rechargeable battery 10 comprises a battery housing 110 and first and second terminals 17 and 37, respectively. During discharging, the battery 10 supplies power to an external circuit with the first terminal 17 acting as the negative terminal and the second terminal 37 acting as the positive terminal of the battery 10. During charging, the battery 10 stores energy from a charger.

FIG. 1B shows the rechargeable battery 10 without the battery housing 110. The battery 10 comprises a first conductor 15, an anode 20, a separator 25, a cathode 30 and a second conductor 35. The first conductor 15 is electrically coupled to the first terminal 17 and the second conductor 35 is electrically coupled to the second terminal 37. In one aspect, the first and second conductors 15 and 35 may extend beyond the anode 20 and the cathode 30 to form the first and second terminals 17 and 37, respectively. The first conductor 15 may also be referred to as a current collector.

In one aspect, the battery housing 110 holds lithium ions in an electrolyte, which may comprise lithium salts dissolved in a solvent. The electrolyte is used to provide aqueous ionic transport of lithium ions between the anode 20 and the cathode 30 through the separator 25. The separator 25 may be made of a porous material that electrically isolates the anode 20 from the cathode 20 while allowing lithium ions to pass through.

To charge the battery 10, lithium ions are extracted from the cathode 30 and transported in the electrolyte to the anode 20, where the lithium ions intercalate into the active material of the anode 20. To supply power to an external circuit, the battery 10 is discharged from the charged state. During discharging, lithium ions are extracted from the active material of the anode 20 and transported to the cathode 30 through the separator 25. This process releases electrons in the active material of the anode 20, which are collected by the first conductor 15. The collected electrons flow to the external circuit through the first terminal 17, which acts as the negative terminal of the battery 10 during discharging. The lithium ions transported to the cathode 30 intercalate into the active material of the cathode 30. This process requires electrons, which are supplied to the active material of the cathode 30 from the second conductor 35. The second conductor 35 may receive the electrons from the external circuit through the second terminal 37, which acts as the positive terminal of the battery 10.

In conventional lithium-ion batteries, the active material of the anode 20 comprises graphite, which has a practical specific capacity of about 350 mAh/g. Silicon has a much higher practical specific capacity of about 3580 mAh/g. As a result, an active material comprising silicon can hold much more lithium in the charged state than an active material comprising graphite, and can therefore dramatically increase the storage capacity of the battery 10.

Because of silicon's high capacity to hold lithium, silicon undergoes a large volume expansion during lithium intercalation when used for the active material of the anode 20. For example, amorphous silicon having a specific capacity of about 3580 mAh/g can increase in volume by 280% when lithium ions intercalate into the silicon to charge the battery 10. This large volume expansion can lead to active material degradation, resulting in a loss of storage capacity of the battery 10 over charge/discharge cycles.

Active material degradation due to volume expansion can be mitigated by using silicon nanoparticles for the active material of the anode 20. The silicon nanoparticles are able to move relative to one another to make room for lithium intercalation. However, separation of the silicon nanoparticles to accommodate the large volume expansion can create voids between the silicon nanoparticles when the battery 10 is subsequently discharged. These voids can cause silicon nanoparticles to become electrically isolated. As a result, electrons are unable to conduct between the electrically isolated silicon nanoparticles and the first conductor 15, leading to a loss of capacity of the battery 10.

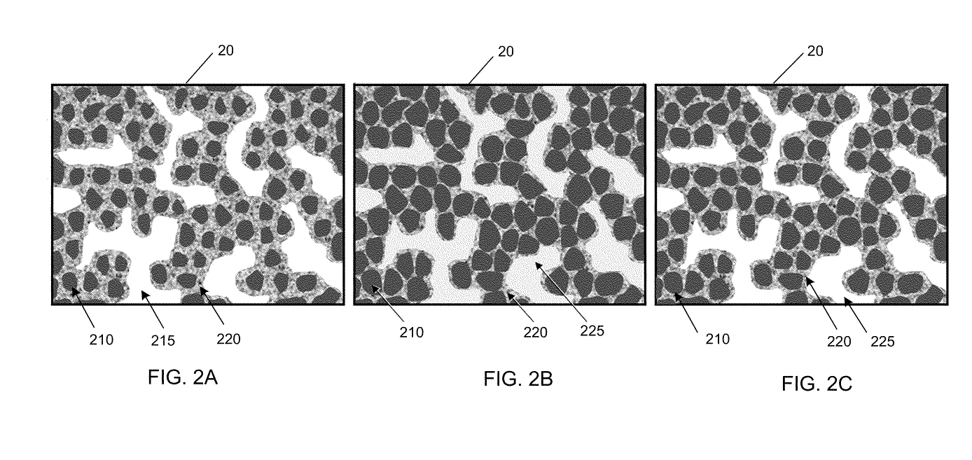

In an aspect of the disclosure, an elastomeric binder is used to bind the silicon nanoparticles in the anode 20 together and prevent electrical isolation of the silicon nanoparticles. FIG. 2A shows an example of the anode 20 according this aspect of the disclosure. The anode 20 may have a thickness in the range of 5 to 500 microns. The anode 20 comprises silicon nanoparticles 210, which are used for the active material of the anode 20. The silicon nanoparticles 210 may have diameters of less than one micron.

The anode 20 also comprises the elastomeric binder 220 binding the silicon nanoparticles 210 together. The binder 220 may be electrically conductive to conduct electrons between the silicon nanoparticles 210 and the first conductor 15. In one aspect, the binder 220 is able to stretch and contract to accommodate large volume changes in the silicon nanoparticles 210 while maintaining electrical conduction between the silicon nanoparticles 210 and the first conductor 15 through the binder 220. As a result, the binder 220 prevents electrical isolation of the silicon nanoparticles 210 due to large volume changes, thereby reducing capacity loss from cycling and improving the cycle life of the battery 10.

The binder 220 may comprise carboxy methyl cellulose (CMC), styrene butadiene rubber (SBR), polyurethane, polyimides, polyamides or a combination thereof. The silicon nanoparticles 210 may be covalently bonded to the binder 220. In one aspect, silicon nanoparticles 210 are chemically functionalized with binder components and/or functional groups that bind with the binder 220. These components may include monomers of an elastomeric polymer, prepolymers, or molecules with functional groups such as alcohols, carboxylates, or alkenes. The monomers may be the same elastomeric polymer that are used for the binder material. Modification of the surface of the anode 20 may take place at the particle surface or the oxide surface of a native oxide layer. The functionalized silicon nanoparticles 210 can then be covalently attached to the binder material 220. According to this aspect, covalent attachment improves the active material-binder interaction, which prevents separation of the active material (silicon nanoparticles) and the binder 220 and therefore reduces capacity loss due to separation and electrical isolation of the active material over charge/discharge cycles.

Conductive additives (e.g., conductive carbon additives) may be added to the binder 220 to make the binder 220 conductive. In one aspect, the conductive additives in the binder 220 may comprise a combination of carbon black and graphite carbon. The carbon black may comprise carbon nanoparticles having diameters of less than one micron to provide particle-to-particle electrical conduction. The graphite carbon may comprise carbon strands having lengths of a few microns (e.g., 6 to 10 microns). The graphite carbon may be used to provide long electron conduction paths in the binder 220.

In one aspect, the anode 20 includes pores 215 that allow the electrolyte to flow into the anode 20 and transport lithium ions to and from the silicon nanoparticles 210. The anode 20 may have a porosity of 25 to 75%. The large surface area-to-volume ratio of the silicon nanoparticles 210 provides the lithium ions in the electrolyte with access to a large surface area of the active material (silicon) of the anode 20.

FIG. 2B shows the anode 20 in the charged state according to an aspect of the disclosure. In this aspect, the pores of the anode 215 are filled with an electrolyte 225 for transporting lithium ions. Individual lithium ions in the electrolyte are not shown in FIG. 2B for ease of illustration. The electrolyte 225 may be prepared by dissolving lithium salt into a solvent. During charging, lithium ions in the electrolyte 225 intercalate into the silicon nanoparticles 210, causing the silicon nanoparticles 210 to expand. FIG. 2B shows the anode 20 in the charged state, in which the silicon nanoparticles 210 have larger volumes compared with the silicon nanoparticles 210 shown in FIG. 2A due to lithium intercalation.

In this aspect, the binder 220 binding the silicon nanoparticles 210 together stretches to accommodate the volume expansion of the silicon nanoparticles 210 due to lithium intercalation. The binder 220 provides electrical conduction between the silicon nanoparticles 210 and the first conductor 15, allowing electrons released during discharging to conduct from the silicon nanoparticles 210 to the first conductor 15.

FIG. 2C shows the anode 20 in a discharged state after discharging from the charged state shown in FIG. 2B according to an aspect of the disclosure. During discharging, lithium ions are extracted from the silicon nanoparticles 210 and transported by the electrolyte 225 from the anode 20 to the cathode 30. This causes the silicon nanoparticles 210 in the anode 20 to contract as shown in FIG. 2C.

In this aspect, the binder 220 contracts to accommodate the volume reduction of the silicon nanoparticles 210. After discharge, the silicon nanoparticles 210 remain bonded to the binder 220, which provides electrical conduction between the silicon nanoparticles 210 and the first conductor 15. The elastomeric binder 220 is robust to large volume changes of the silicon nanoparticles over charge/discharge cycles. Thus, the elastomeric binder 220 prevents separation and electrical isolation of the silicon nanoparticles 210 after discharge, and therefore reduces capacity loss of the battery 10 from cycling.

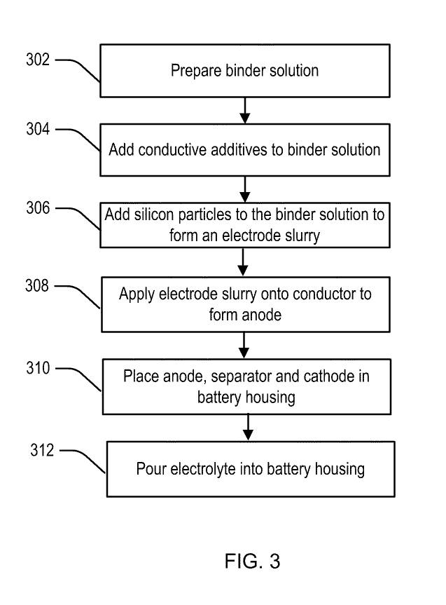

An example of a process for fabricating the battery 10 according to an aspect of the disclosure will now be discussed with reference to FIG. 3.

In step 302, a binder solution is prepared. The binder solution may be prepared by adding water or solvent to carboxy methyl cellulose (CMC), styrene butadiene rubber (SBR), polyurethane, polyimides, polyamides, polymer or a combination thereof. For example, the binder material may comprise sodium carboxy methyl cellulose (NaCMC) having a molecular weight (MW) of 90,000 and a degree of substitution (DS) of 0.7.

In one example, the binder solution is prepared by adding 142.5 g of DI water to 7.5 g of NaCMC (MW 90,000, DS 0.70) and mixing the mixture overnight. In this example, a 5% NaCMC binder solution is formed. The binder solution may also comprise a composite of CMC and SBR. The composite may comprise 25%-100% CMC with the remainder comprising SBR.

In step 304, conductive additives are added to the binder solution. The conductive additives may comprise carbon nanoparticles, graphite carbon or a combination thereof. In one example, 3.25 g of Super P (carbon black) is added to 130 g of the 5% NaCMC binder solution to form a 2:1 NaCMC:Super P slurry. The conductive binder solution may be mixed with a homogenizer and placed in a sonicator for uniform dispersion. The binder solution may be mixed with the homogenizer for 5 minutes and the sonicator for 15 minutes. The binder solution may then be mixed further with the homogenizer for 5 minutes and the sonicator for 15 minutes.

In step 306, silicon nanoparticles are added to the binder solution with the conductive additives to form an electrode slurry. The silicon nanoparticles may have diameters of 100 nanometers or less. In one example, 20 g of silicon nanoparticles are added to of 60 g ethanol to wet the silicon nanoparticles. The silicon nanoparticles may have diameters of 100 nm or less, e.g., 50 nm. 40 g of an ethanol and water solution having an ethanol to water ratio of 1:1 by weight is added to the wetted silicon nanoparticles to further wet the silicon nanoparticles. 117.6 g of the 2:1 NaCMC:Super P slurry is then added to the wetted silicon nanoparticles to form the electrode slurry. The silicon nanoparticles may also be wetted with a CMC solution. The wetting process makes the silicon nanoparticles more compatible with the binder material by chemically functionalizing the silicon with binder components and/or functional groups that bind with the binder material. The binder components may come from a CMC solution used to wet the silicon nanoparticles or the functional groups may come from OH functional groups of an alcohol (e.g., ethanol) used to wet the silicon nanoparticles. The electrode slurry may be mixed for a few minutes, e.g., 5 to 10 minutes, with a homogenizer.

In step 308, the electrode slurry is applied onto a conductor to form the anode 20. The applied electrode slurry may be dried and calendered to a desired anode thickness. In one example, the electrode slurry is cast onto a sheet of copper (e.g., 18 microns thick). A doctor blade with a 6 mil (approximately 150 microns) side is pulled down the copper sheet with the electrode slurry to form an even electrode film on the copper sheet. The electrode film is then air dried until all dark spots disappear and placed in a vacuum oven overnight at 70 C to fully dry. After drying, the electrode film is calendered to a target film thickness of approximately 50 microns. The dried electrode film forms a porous anode 20 and the copper sheet forms a first conductor 15 of the battery 10. Thus, steps 302 to 308 of the process in FIG. 3 may be used to form the anode 20 of the battery 10.

The anode material may comprise 60% to 90% silicon with the remaining amount comprising the binder material and conductive additives. The ratio of binder material to conductive additives may be 2:1 by weight or other ratio, e.g., 0.5:1 to 4:1.

In step 310, the anode 20, a separator 25 and a cathode 30 are placed in a battery housing 110. The battery housing 110 may comprise an aluminized pouch or other container. The anode 20 and the cathode 30 may be stacked on one another with the separator 25 interposed between the anode 20 and the cathode 30. The stack may be clamped together to ensure that the anode 20 and the cathode 30 stay in close contact with the separator 25. The separator 25 may comprise Celgard 2400 or other porous material that allows ions to pass through while providing electrical isolation between the anode 20 and the cathode 30. The cathode 30 may comprise lithium iron phosphate (LiFePO₄) or other material known in the art. The cathode 30 may be a phosphate, cobalt or nickel based. The cathode 30 may be attached to a second conductor 35.

In step 312, an electrolyte 225 is poured into the battery housing 110. The electrolyte 225 may comprise lithium salt dissolved in a solvent. In one example, the electrolyte 225 may comprise LiPF₆ dissolved in a 1:1:1 solution of ethylene carbonate (EC), diethyl carbonate (DEC) and dimethyl carbonate (DMC). After the electrolyte is poured into the battery housing 110, the battery housing 110 may be vacuum sealed with the first and second terminals 17 and 37 electrically coupled to the first and second conductors 15 and 35, respectively.

When the battery 10 is initially charged, the electrolyte 225 may form a solid electrolyte interface (SEI) that provides electrical isolation between the silicon nanoparticles 210 and the electrolyte 225 while allowing lithium ions to conduct between the silicon nanoparticles 210 and the electrolyte 225.

It is understood that the specific order or hierarchy of steps in the processes disclosed is an illustration of exemplary approaches. Based upon design preferences, it is understood that the specific order or hierarchy of steps in the processes may be rearranged. Some of the steps may be performed simultaneously. The accompanying method claims present elements of the various steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the invention.

In one aspect, the term “element(s)” may refer to a component(s). In another aspect, the term “element(s)” may refer to a substance(s). In yet another aspect, the term “element(s)” may refer to a compound(s).

Terms such as “top,” “bottom,” “front,” “rear” and the like as used in this disclosure should be understood as referring to an arbitrary frame of reference, rather than to the ordinary gravitational frame of reference. Thus, a top surface, a bottom surface, a front surface, and a rear surface may extend upwardly, downwardly, diagonally, or horizontally in a gravitational frame of reference.

A phrase such as an “aspect” does not imply that such aspect is essential to the subject technology or that such aspect applies to all configurations of the subject technology. A disclosure relating to an aspect may apply to all configurations, or one or more configurations. An aspect may provide one or more examples of the disclosure. A phrase such as an aspect may refer to one or more aspects and vice versa. A phrase such as an “aspect” does not imply that such aspect is essential to the subject technology or that such aspect applies to all configurations of the subject technology. A disclosure relating to an aspect may apply to all aspects, or one or more aspects. An aspect may provide one or more examples of the disclosure. A phrase such an aspect may refer to one or more aspects and vice versa. A phrase such as a “configuration” does not imply that such configuration is essential to the subject technology or that such configuration applies to all configurations of the subject technology. A disclosure relating to a configuration may apply to all configurations, or one or more configurations. A configuration may provide one or more examples of the disclosure. A phrase such a configuration may refer to one or more configurations and vice versa.

The word “exemplary” is used herein to mean “serving as an example or illustration.” Any aspect or design described herein as “exemplary” is not necessarily to be construed as preferred or advantageous over other aspects or designs.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.” Furthermore, to the extent that the term “include,” “have,” or the like is used in the description or the claims, such term is intended to be inclusive in a manner similar to the term “comprise” as “comprise” is interpreted when employed as a transitional word in a claim.

What is claimed is:

1. A rechargeable battery, comprising:
a first conductor;
an anode attached to the first conductor, the anode comprising:
a plurality of silicon nanoparticles; and
an elastomeric binder binding the plurality of silicon nanoparticles together;
a second conductor;
a cathode attached to the second conductor; and
an electrolyte for transporting lithium ions between the anode and the cathode.

2. The rechargeable battery of claim 1, wherein the plurality of silicon nanoparticles have diameters of 100 nanometers or less.

3. The rechargeable battery of claim 1, wherein the elastomeric binder includes conductive additives to conduct electrons between the first conductor and the plurality of silicon nanoparticles through the binder.

4. The rechargeable battery of claim 3, wherein the conductive additives comprise carbon nanoparticles.

5. The rechargeable battery of claim 3, wherein the conductive additives comprise carbon black, graphite or a combination thereof.

6. The rechargeable battery of claim 1, wherein the elastomeric binder is covalently bonded to the silicon nanoparticles.

7. The rechargeable battery of claim 6, wherein the elastomeric binder is covalently bonded to the silicon nanoparticles by carboxyl or alkoxy groups.

8. The rechargeable battery of claim 1, wherein the elastomeric binder comprises carboxy methyl cellulose (CMC), styrene butadiene rubber (SBR), polyurethane, polyimides or a combination thereof.

9. The rechargeable battery of claim 1, wherein the anode comprises 60% to 90% by weight of the plurality of silicon nanoparticles.

10. The rechargeable battery of claim 1, further comprising a separator disposed between the anode and the cathode and configured to pass lithium ions while providing electrical isolation between the anode and the cathode.

11. The rechargeable battery of claim 1, wherein the electrolyte comprises a lithium salt in a solvent.

12. A method for fabricating an anode of a rechargeable battery, comprising:
preparing a binder solution;
adding conductive additives and silicon nanoparticles to the binder solution to form an electrode slurry;
applying the electrode slurry onto a conductor; and
drying the electrode slurry on the conductor to form the anode.

13. The method of claim 12, wherein the silicon nanoparticles have diameters of 100 nanometers or less.

14. The method of claim 12, wherein the conductive additives comprise carbon nanoparticles.

15. The method of claim 12, wherein the conductive additives comprise carbon black, graphite or a combination thereof.

16. The method of claim 12, wherein the binder solution comprises carboxy methyl cellulose (CMC), styrene butadiene rubber (SBR), polyurethane, polyimides or a combination thereof.

17. The method of claim 12, further comprising wetting the silicon nanoparticles prior to adding the silicon nanoparticles to the binder solution.

18. The method of claim 17, wherein the silicon nanoparticles are wetted with a wetting solution comprising elastomer components, functional groups or a combination therefore.

19. The method of claim 11, wherein the anode comprises 60% to 90% by weight of the silicon nanoparticles.

20. An anode formed on a conductor for a rechargeable battery, comprising:
a plurality of silicon nanoparticles;
an elastomeric binder binding the plurality of silicon nanoparticles together, wherein the elastomeric binder is attached to the conductor; and
conductive additives in the elastomeric binder for conducting electrons between the conductor and the plurality of silicon nanoparticles.

21. The anode of claim 20, wherein the plurality of silicon nanoparticles have diameters of 100 nanometers or less.

22. The anode of claim 20, wherein the conductive additives comprise carbon nanoparticles.

23. The anode of claim 20, wherein the elastomeric binder is covalently bonded to the silicon nanoparticles.

24. The anode of claim 23, wherein the elastomeric binder is covalently bonded to the silicon nanoparticles by carboxyl or alkoxy groups.

25. The anode of claim 20, wherein the elastomeric binder comprises carboxy methyl cellulose (CMC), styrene butadiene rubber (SBR), polyurethane, polyimides or a combination thereof.

26. The anode of claim 20, wherein the anode comprises 60% to 90% by weight of the plurality of silicon nanoparticles.

27. The anode of claim 20, wherein the anode has a thickness of 5 to 500 microns.
